(19) United States
(12) Patent Application Publication
(10) Pub. No.: US 2003/0167575 A1
(43) Pub. Date: Sep. 11, 2003

(54) Method for coloring acrylic fibers

(76) Inventors: Brian Alan Connolly, Taipei (TW); Rainer Casaretto, Hennef (DE); Frank Grundmann, Leverkusen (DE); Dieter Steffens, Bergisch-Gladbach (DE)

Correspondence Address: CONNOLLY BOVE LODGE & HUTZ, LLP, 1220 N MARKET STREET, P O BOX 2207, WILMINGTON, DE, 19899

(21) Appl. No.: 10/296,409

(22) PCT Filed: May 30, 2001
(86) PCT No.: PCT/EP01/06132

(30) Foreign Application Priority Data
Jun. 2, 2000 (DE) 100 27 338.6

(51) Int. Cl. D06M 10/00; C09B 62/00

(52) U.S. Cl. 8/115.51

(57) ABSTRACT

The novel process for dyeing non-cationically-modified polyacrylonitrile fibers during spinning when the fibers are in the gel state which comprises using at least one anionic dye from the group of the acid dyes, the direct dyes or the reactive dyes and provides deep dyeings having good general fastnesses.

The present invention relates to a novel process for dyeing polyacrylonitrile fibers in the gel state during fiber formation. The invention further relates to the use of anionic dyes for this dyeing process.

It is long known that polyacrylonitrile can be dyed with cationic dyes. However, pure polyacrylonitrile is very difficult to dye. It is therefore customary to include ionic and nonionic comonomers in the polymerization. The ionic comonomers have sulfo or sulfonate groups and so permit the chemical binding of ionic dyes whose coloring ion is a cation (basic dyes). The nonionic comonomers serve as internal plasticizers and may help to increase the rate of absorption of the dyes in dyeing. It is further known that such polyacrylonitrile fibers can be dyed with cationic dyes by the exhaust process or during the spinning process when the fibers are in the gel state. Such processes are described for example in GB-A 991 957, GB 992 195 and GB 1 056 731.

It is also known to use basic comonomers (for example vinylpyridines or aliphatic amines) in the preparation of polyacrylonitrile fiber. Such cationically modified polyacrylonitrile fibers can be dyed with anionic dyes.

It has now been found that, surprisingly, polyacrylonitrile fibers without cationic modification can be dyed with anionic dyes during spinning when the fibers are in the gel state.

The present invention accordingly provides a process for dyeing non-cationically-modified polyacrylonitrile fibers during spinning when the fibers are in the gel state, which comprises using as dye at least one anionic dye from the group of the acid dyes, the direct dyes or the reactive dyes.

The acrylonitrile content of the polyacrylonitrile fiber can vary and depends on the type of fiber and the stage of the processing operation. For the purposes of the present invention polyacrylonitrile fibers are fibers that consist of not less than 85% by weight of polymerized acrylonitrile. Preferably the polyacrylonitrile fibers to be dyed according to the invention are ternary copolymers containing 89-95% by weight of acrylonitrile, 4-10% by weight of a nonionic comonomer and 0.5-1% by weight of an ionic comonomer having at least one sulfo or sulfonate group.

Useful nonionic comonomers include in particular: dicyanoethylene, itaconic acid, polyethylene oxide, vinylidene chloride, methyl acrylate, methyl methacrylate, vinyl acetate or vinyl chloride.

Useful ionic comonomers include in particular: AMPS (2-acrylamido-2-methylpropanesulfonate), allylsulfonate, methallylsulfonate, styrenesulfonic acid or vinylsulfonic acid.

Furthermore, polyacrylonitrile fibers to be dyed according to the invention are also to be understood as meaning modacrylic fibers. Modacrylic fibers contain preferably less than 85% by weight, especially 50 to 80% by weight, of polymerized acrylonitrile, 49 to 12% by weight of copolymerized vinyl chloride or vinylidene chloride, 1 to 3% by weight of an ionic comonomer, preferably styrenesulfonic acid and methallylsulfonate, and also 0 to 5% by weight of a nonionic comonomer, preferably alkylacrylamide, the sum total of all constituents being 100% by weight.

The process of the invention is used in the realm of the wet-spinning process. During the spinning step, the fiber-forming acrylonitrile polymer, which was previously dissolved in a solvent, is spun into an aqueous coagulation bath to form polyacrylonitrile fibers.

Useful solvents for the fiber-forming acrylonitrile polymer include for example dimethylformamide, dimethylacetamide, acetone, nitrophenol, oxypyrrolidones and dimethyloxamides and also aqueous solutions of zinc chloride, sodium thiocyanate, ammonium thiocyanate and nitric acid.

The process of the invention is an in-line process for dyeing wet-spun polyacrylonitrile fibers in the gel state, and this process is known in principle. The dyebath can be positioned at different points in the spinning line during the dyeing process. Customarily the dyebath is positioned either during the partial orientation phase, after the partial orientation phase or after the full orientation phase.

The term “gel state” as used herein relates to acrylonitrile fibers immediately on leaving the spinneret up to the point immediately before fiber formation is complete. A fiber in the gel state customarily has a water content of 2 to 90% by weight and may contain up to 30% by weight of solvent. Water and solvent are mainly added in polymer preparation and so end up in the fiber which forms. The water may build up in the fiber, especially during the wash phases of the production process, while solvent is removed at the same time. As the fiber is stretched, the water content of the fiber is reduced more and more.

After leaving the gel state, the finished fiber has no or only a very low water content of about 0 to 1.5% by weight and contains at most residues of solvents in the ppm range. When the dyebath is used during the partial orientation phase, the fiber is still very amorphous and is dyed very rapidly. At this stage, however, the solvent content of the fiber is still very high, which leads to rapid contamination of the dyebath. Moreover, the fiber is very sensitive at this stage. Fiber speed is about 2 to 14 m/min, preferably 8 to 14 m/min. When the dyebath is positioned below the partial orientation phase, the polyacrylonitrile fiber is already stabilized. The partial orientation and washing operation has already removed virtually all solvent residues, which is advantageous in the case of the use of aqueous sodium thiocyanate or ammonium thiocyanate as solvent in particular. Fiber speed is about 4 to 42 m/min, preferably 18 to 28 m/min, and is thus still slow enough to permit exhaustion of the dyebath in about 0.4 to 8, preferably 0.5 to 5, seconds. The dyeing rate is the highest in this case. By connecting a wash bath to the dyebath it is possible to remove unfixed dye portions. The positioning of the dyebath in this position of the spinning line is preferred. Positioning of the dyebath downstream of the full orientation of the polyacrylonitrile fiber is also possible. Here the advantage is that the solvent content of the fiber is then very low.

The disadvantage is that the fiber speed is very high in this phase of the spinning process, namely is generally 60 to 140 m/min, preferably 100 to 140 m/min, which impairs sufficient exhaustion of the dyebath. Furthermore, the affinity of the fiber is very low, which necessitates a higher dyebath concentration when deeper shades are to be dyed.

Useful gel dyeing baths include in principle all kinds of prior art dyebaths, ranging from very simple dyebaths to complicated dyebaths featuring high liquor circulation, splash boards, air passes and steam passes. The contact time of the fiber with the dyebath is 0.3 to 10 sec on average. The temperature of the dyebath is generally 20 to 95° C., preferably 30 to 60° C.

Useful acid dyes for the process of the invention belong to the following classes of dye: mono or polyazo dyes, anthraquinone dyes, triphenylmethane dyes, triphendioxazine dyes, phthalocyanine dyes, metal complex dyes, xanthene dyes and thiazine dyes, which preferably have one or two sulfo and/or carboxyl groups. Such dyes are listed in the Colour Index, where they are subdivided according to their application properties into metal complex dyes, leveling dyes, semimilling dyes and milling dyes.

Useful 1:1 metal complex dyes include in particular:

| | |
|---|---|
| Acid Yellow | 54, 99, 104 |
| Acid Orange | 74 |
| Acid Red | 179, 183, 184, 186, 194, 195, 201, 214 |
| Acid Green | 12, 35 |
| Acid Violet | 58 |
| Acid Blue | 158, 161, 314 |
| Acid Black | 52 |

Useful 1:2 metal complex dyes include 1:2 metal complex dyes with no sulfo groups and 1:2 metal complex dyes with one or two sulfo groups and/or carboxyl groups.

Preference is given in particular to the following 1:2 metal complex dyes:

| | |
|---|---|
| CI Acid Yellow | 59, 112, 116, 121, 123, 128, 129 140, 151, 155, 194 220, 223, 231, 232, |
| | 235, 237 and 241 |
| CI Acid Orange | 139, 142, 144, 154, 166 and 168 |
| Cl Acid Red | 315, 359, 362, 383, 399, 405, 414, 416 and 425 |
| CI Acid Violet | 90, 121, 127 and 128 |
| CI Acid Brown | 282, 283, 289, 298, 355, 357, 363, 365, 402, 413, 415 and 423 |
| CI Acid Green | 60, 73, 104, 106, 108, 109, 113, 116, 119 |
| CI Acid Blue | 193, 284, 296, 300, 317, 335, 342 |
| CI Acid Black | 58, 60, 63, 99, 107, 112, 118, 132, 140, 164, 172, 177, 187, 188, 194, 197, |
| | 207, 218, 220, 211, 334 |
| Particularly preferred leveling dyes are the following: | |
| Acid Yellow | 17, 23, 42, 49, 172, 199 |
| Acid Orange | 3, 7 |
| Acid Red | 1, 37, 57, 73, 88, 97, 119, 249 |
| Acid Blue | 25, 40, 41, 43, 62, 69, 80, 92 |
| Acid Black | 1 |
| Particularly preferred semimilling dyes are the following: | |
| Acid Yellow | 19, 40, 61 |
| Acid Orange | 43, 136 |
| Acid Red | 118,301,336 |
| Acid Violet | 47 |
| Acid Blue | 82, 92, 129 278 |
| Particularly preferred milling dyes are the following: | |
| Acid Yellow | 79, 40, 110, 127, 75, 70 |
| Acid Orange | 111, 97, 145 |
| Acid Red | 274, 129, 289, 276, 303, 122 |
| Acid Blue | 221, 175, 274, 261, 272, 143, 204, 225, 140 |

Acid Black 24, 26

Useful direct dyes for the process of the invention are those of the classes of the mono- or polyazo dyes and of the anthraquinone, triphendioxazine, metal complex and xanthene dyes which preferably have one or two sulfo and/or carboxyl groups.

Preferred direct dyes are:

| | |
|---|---|
| Direct Yellow | 39, 41, 28, 27, 55, 68, 93, 96, 98, 106, 169 |
| Direct Orange | 34, 51, 46, 106, 66, 70, 60, 15, 26 |
| Direct Red | 9, 16, 89, 80, 81, 83, 224, 227, 173, 184, 221, 99, 84, 92, |
| Direct Green | 26, 27, 28, 67, 69 |
| Direct Violet | 9, 51, 66 |
| Direct Brown | 112,103,115,172,212,162,157,175 |
| Direct Blue | 75, 76, 71, 85, 86, 78, 80, 94, 106, 167, 189, 199, 207, 211, 212, 218, 78, |
| | 158, 175, 166, 169 |
| Direct Black | 19, 22, 112, 113, 62, 17, 122, 91, 116, 52 |

Useful reactive dyes include in principle the following classes of dyes which have at least one reactive group: mono- or polyazo dyes, metal complex dyes, triphendioxazine dyes and also phthalocyanine dyes.

The dye classes mentioned preferably have one or two reactive groups selected from the group consisting of monochlorotriazine, dichlorotriazine, sulfatoethyl sulfone, triacrylolylformal, formaldehyde derivatives, trichloropyrimidine, (alkoxy)monochlorotriazine, monochlorodifluoropyrimidine, dichlorophthalazine, methyltaurinoethyl sulfone, sulfatoethylsulfonacrylamide, α-bromoacrylamide, dichloropyridazone, acrylamide, N(β-chloroethyl)sulfonamide, dichloropyrimidinecarboxamide, vinyl sulfone, dichloroquinoxaline, methylsulfonylchloromethylpyrimidine, monofluorotriazine, methylfluorochloropyrimidine, alkyl- or arylphosphonic acid, 3 carboxypyridinium-1-3-5-triazine (triazine-nicotinic acid).

Of the reactive dyes, the following are preferred:

| | |
|---|---|
| Reactive Yellow | 3, 18, 22, 86, 154, 30, 60, 11, 55, 111, 66, 37:1, 123, 39, 113, 5, 59, 37, |
| | 125, 143, 148, 132 |
| Reactive Orange | 4, 72, 49, 87, 52, 79, 48, 89 |
| Reactive Red | 3, 58, 2, 11, 109B, 47, 92, 56, 151, 124, 97, 21:1, 166, 83, 155, 30, 91, |
| | 23, 41, 184, 196, 186 |
| Reactive Blue | 2, 13, 32, 109, 19B, 62, 88, 10, 74, 113, 93, 155, 150, 69, 6, 84, 19, |
| | 114, 182, 172 |
| Reactive Violet | 5B, 33, 31, 37 |
| Reactive Brown | 5, 21 |
| Reactive Black | 5, 25 |

The dyes may be added to the dyebath in customary form, for example in the form of aqueous solution which may optionally contain further assistants such as, for example, quaternary araliphatic ammonium compounds.

The dyeings obtained are notable for depth of shade and very good fastnesses, especially light- and wetfastnesses.

The examples which follow illustrate the process of the invention. All percentages are by weight, unless otherwise stated.

### EXAMPLES

### Example 1

A spinning solution was prepared from 25% by weight of polyacrylonitrile and 75% by weight of dimethylformamide (DMF). This solution was spun at 60° C. into a spin bath of aqueous DMF (DMF content 10 to 20% by weight). The tow was washed 4 times and partially oriented 3 times. The tow thus obtained had a composition of 560 kilotex with a water content of 20% by weight and a DMF content of 5% by weight. The tow was then passed through a dyebath at a speed of 15 m/min. The immersion time was 0.5 sec at a temperature of 75° C. The dyebath contained 0.1% by weight of Reactive Yellow 015, 0.2% by weight of Reactive Red 180 and 4.7% by weight of Reactive Black 5, based on the ready-produced tow. The tow was then washed 2 more times, filly oriented and then dried at 180° C. for 30 sec.

A thoroughly through-dyed black filament of good wetfastness was obtained.

### Example 2

A spinning solution was prepared from 13% by weight of polyacrylonitrile, 40% by weight of sodium thiocyanate (NaSCN) and 37% by weight of water. This solution was spun into a spin bath of aqueous sodium thiocyanate solution (NaSCN content 5 to 20% by weight) at a temperature of 2° C. The tow was washed 4 times and partially oriented 2 times. The tow thus obtained had a composition of 3 300 kilotex with a water content of 30% by weight and an NaSCN content of less than 100 ppm. The tow was then passed through a dyebath at a speed of 25 m/min. The immersion time was 4 sec at a temperature of 60° C. The dyebath contained 0.3% by weight of Acid Yellow 242, 0.2% by weight of Acid Red 425 and 3.2% by weight of Acid Black 099 based on the ready-produced tow. The tow was subsequently washed 2 more times, fully oriented and then dried at 120° C. for 6 min.

A thoroughly through-dyed deep gray filament having good wet- and lightfastness was obtained.

What is claimed is:

1. A process for dyeing non-cationically-modified polyacrylonitrile fibers during spinning when the fibers are in the gel state, which comprises using as dye at least one anionic dye from the group of the acid dyes, the direct dyes or the reactive dyes.

2. A process as claimed in claim 1, wherein the polyacrylonitrile fibers are ternary copolymers containing 89-95% by weight of acrylonitrile, 4-10% by weight of a nonionic comonomer and 0.5-1% by weight of an ionic comonomer having at least one sulfo or sulfonate group.

3. A process as claimed in claim 2, wherein the nonionic comonomer is dicyanoethylene, itaconic acid, polyethylene oxide, vinylidene chloride, methyl acrylate, methyl methacrylate, vinyl acetate or vinyl chloride and the ionic comonomer is AMPS (2-acrylamido-2-methylpropanesulfonate), allylsulfonate, methallylsulfonate, styrenesulfonic acid or vinylsulfonic acid.

4. A process as claimed in claim 1, wherein the polyacrylonitrile fibers are modacrylics containing 50 to 80% by weight of acrylonitrile, 49 to 12% by weight of vinyl chloride and/or vinylidene chloride, 0 to 5% by weight of a nonionic comonomer and 1 to 3% by weight of an ionic comonomer having at least one sulfo or sulfonate group.

5. A process as claimed in any of claims 1 to 4, wherein the dyeing during spinning is carried out either during the partial orientation phase, after the partial orientation phase or after the full orientation phase.

6. A process as claimed in any of claims 1 to 5, wherein acid dyes used are from the classes of the mono- or polyazo dyes, anthraquinone dyes, triphenylmethane dyes, triphendioxazine dyes, phthalocyanine dyes, metal complex dyes, xanthene dyes and thiazine dyes.

7. A process as claimed in any of claims 1 to 5, wherein direct dyes used are from the classes of the monoazo or polyazo dyes, anthraquinone dyes, triphendioxazine dyes, metal complex dyes and xanthene dyes.

8. A process as claimed in any of claims 1 to 5, wherein reactive dyes used are from the classes of the mono- or polyazo dyes, metal complex dyes, triphendioxazine dyes and also phthalocyanine dyes which have at least one reactive group.

9. Use of anionic dyes from the group of the acid dyes, and direct dyes or reactive dyes for dyeing non-cationically-modified polyacrylonitrile fibers in the gel state.
